(19) United States
(12) Patent Application Publication
(10) Pub. No.: US 2014/0165959 A1
(43) Pub. Date: Jun. 19, 2014

(54) ENGINE HAVING VARIABLE VALVE TIMING DEVICE AND VARIABLE TUMBLE DEVICE

(71) Applicants: Kia Motors Corporation, Seoul (KR); Hyundai Motor Company, Seoul (KR)

(72) Inventors: Dong Hee Han, Seoul (KR); Seung Kook Han, Suwon-si (KR); Dae Yoon Oh, Gwangmyeong-si (KR); Wootae Kim, Anyang-si (KR); Dong Ho Chu, Ansan-si (KR); Jong Il Park, Seoul (KR); Yoon Joo Kim, Yongin-si (KR); Hyuk Im, Suwon-si (KR); Hyun Jun Lim, Incheon (KR)

(73) Assignees: Kia Motors Corporation, Seoul (KR); Hyundai Motor Company, Seoul (KR)

(21) Appl. No.: 13/907,676

(22) Filed: May 31, 2013

(30) Foreign Application Priority Data
Dec. 17, 2012 (KR) 10-2012-0147778

(51) Int. Cl. F01L 1/26; F02B 31/06

(52) U.S. Cl. CPC F01L 1/267; F02B 31/06
USPC 123/306

(57) ABSTRACT

An engine having a variable valve timing device and a variable tumble device, may include the variable valve timing device advancing or delaying a rotation of an intake camshaft or an exhaust camshaft, an intake valve or an exhaust valve configured to be operated by the intake camshaft or the exhaust camshaft respectively to open and close an intake port or an exhaust port, and the variable tumble device that may be disposed on an upstream side of the intake valve in the intake port and changes a flow of a gas being suck to form a tumble in a combustion chamber.

### CROSS-REFERENCE TO RELATED APPLICATION

The present application claims priority to Korean Patent Application No. 10-2012-0147778 filed on Dec. 17, 2012, the entire contents of which is incorporated herein for all purposes by this reference.

### BACKGROUND OF THE INVENTION

1. Field of the Invention

The present invention relates to an engine capable of reducing fuel consumption using a variable valve timing device for advancing or delaying a rotation of a camshaft and a variable tumble device for variably forming a tumble in an absorbed gas.

2. Description of Related Art

An internal combustion engine is applied to various fields and such various application fields require various load and speed conditions. It is difficult to design an engine due to the various load and speed conditions.

An engine designed to be operated by special speed and load may be insufficient and may not be driven at required various speeds and loads. Therefore, various technologies for improving driving efficiency of an engine at required speeds and loads are introduced.

One of such technologies is a variable valve timing device. That is, one of such technologies is variably controlling valve operating timing of an exhaust valve or an intake valve in accordance with a driving condition of an engine. By doing so, optimal valve operating timing is selected.

In relation to the above, a concept of formation of a tumble in a combustion chamber is introduced so that very efficient effect may be obtained at low speed and load.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine having a variable valve timing device and a variable tumble device in which the variable valve timing device variably applies operation timing of a valve and combustion efficiency is improved by forming a tumble.

In an exemplary embodiment of the present invention, an engine having a variable valve timing device and a variable tumble device, may include the variable valve timing device advancing or delaying a rotation of an intake camshaft or an exhaust camshaft, an intake valve or an exhaust valve configured to be operated by the intake camshaft or the exhaust camshaft respectively to open and close an intake port or an exhaust port, and the variable tumble device that is disposed on an upstream side of the intake valve in the intake port and changes a flow of a gas being suck to form a tumble in a combustion chamber.

The variable tumble device may include a first tumble arm having a first end rotatably coupled to a hinge and extending into the intake port in a flow direction of the gas suck by the intake port, a second tumble arm integrated with a second end of the first tumble arm and being extended from the first tumble arm in the flow direction of the gas that flows through the intake port, and a driver coupled to the first tumble arm and selectively rotating the first tumble arm around the hinge.

The variable valve timing device is disposed to correspond to the intake camshaft to delay a rotation of the intake camshaft and to reduce a valid compression ratio.

An intake valve closing (IVC) time of the intake valve is an angular displacement of a crankshaft after a bottom dead center (BDC) that is no less than 90 degrees.

The variable valve timing device delays an operation angle of the intake camshaft by no less than 75 degrees.

As described above, in the engine having a variable valve timing device and a variable tumble device according to the exemplary embodiment of the present invention, the variable valve timing device may variably operate operation timing of a valve and combustion efficiency may be improved by forming a tumble.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graph illustrating variable timing of an intake valve in an engine having a variable valve timing device and a variable tumble device according to an exemplary embodiment of the present invention.

FIG. 2 is a schematic block diagram of an engine having a variable valve timing device and a variable tumble device according to an exemplary embodiment of the present invention.

FIG. 3 is a graph illustrating a main driving region of an engine having a variable valve timing device and a variable tumble device according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

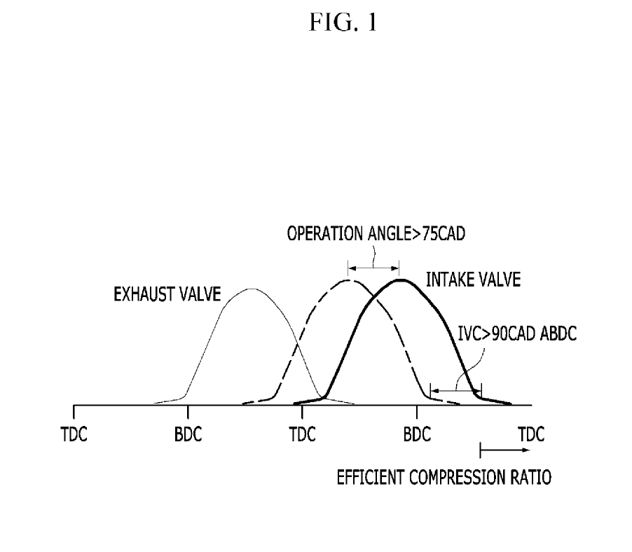

FIG. 1 is a graph illustrating variable timing of an intake valve in an engine having a variable valve timing device and a variable tumble device according to an exemplary embodiment of the present invention.

Referring to FIG. 1, a horizontal axis represents an angle of a crankshaft, TDC represents an angle of a crankshaft when a piston is in a top dead center, and BDC represents an angle of a crankshaft when a piston is in a bottom dead center.

A vertical axis represents lifts of an exhaust valve and an intake valve. According to an exemplary embodiment of the present invention, an operation range of an intake valve is variably delayed or advanced.

An operation angle (an operation range) of the intake valve is the angle of the crankshaft, which is about no less than 75 degrees. Furthermore, intake valve closing (IVC) time is after 90CAD ABDC.

Here, 90CAD means 90 degrees as a crank angle and ABDC means after BDC. That is, the IVC time means after BDC and after a crank angle of 90 degrees.

According to an exemplary embodiment of the present invention, a rotation angle of the crankshaft, that is, the crank angle is sensed by an additional crank angle sensor and operation timing of the intake valve or the exhaust valve is controlled in accordance with the crank angle, a rotation speed, and a load.

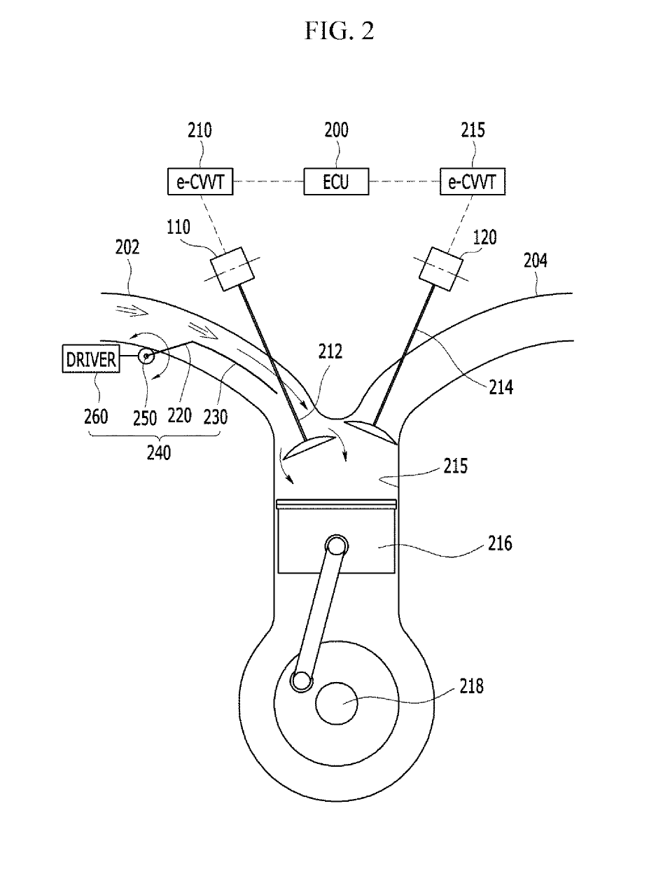

FIG. 2 is a schematic block diagram of an engine having a variable valve timing device and a variable tumble device according to an exemplary embodiment of the present invention.

Referring to FIG. 2, an engine having a variable valve timing device and a variable tumble device includes a controller 200, a variable intake valve timing device 210, a variable exhaust valve timing device 215, an intake valve 212, an exhaust valve 214 extending into an exhaust port 204, a variable tumble device 240, a piston 216, and a crankshaft 218.

According to an exemplary embodiment of the present invention, the exhaust valve 214 may not include the variable exhaust valve timing device 215.

An intake camshaft 110 lifts the intake valve 212 to a predetermined height at predetermined time. The variable intake valve timing device 210 delays or advances lift time of the intake valve 212 by control of the controller 200.

An exhaust camshaft 120 lifts the exhaust valve 214 to a predetermined height at predetermined time. The variable exhaust valve timing device 215 delays or advances lift time of the exhaust valve 214 by control of the control portion 200.

The variable tumble device 240 includes a driver 260, a hinge 250, a first tumble arm 220, and a second tumble arm 230. One end of the first tumble arm 220 is rotatably disposed around the hinge 250 and the other end of the first tumble arm 220 is extended toward a center of an intake port 202.

The second tumble arm 230 is integrated with the first tumble arm 220 and is extended along the intake port 202 to form a predetermined angle with the first tumble arm 220.

The driver 260 rotates the first tumble arm 220 around the hinge 250 to change a direction of flow of an intake gas that flows through the intake port 202 and to form a tumble in a combustion chamber 215. The tumble increases combustion efficiency in the combustion chamber in a combustion process.

Furthermore, the variable intake valve timing device 210 and the variable exhaust valve timing device 215 variably control lift timings of the intake valve 212 and the exhaust valve 214 in accordance with a driving condition to increase an output and a torque.

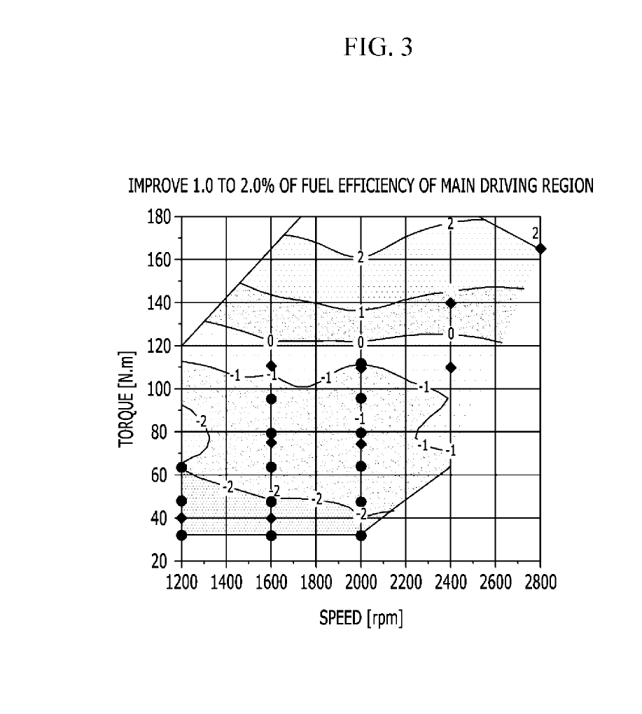

FIG. 3 is a graph illustrating a main driving region of an engine having a variable valve timing device and a variable tumble device according to an exemplary embodiment of the present invention.

Referring to FIG. 3, a horizontal axis represents revolutions per minute (RPM) of an engine and a vertical axis represents an output torque.

As illustrated in FIG. 3, in a main practical region where RPM of an engine is 1,200 to 2,200 RPM and an output torque is 50 to 100 NMm, 1 to 2% of fuel consumption is reduced. The above effect is obtained by simultaneously using the variable valve timing device and the variable tumble device.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine having a variable valve timing device and a variable tumble device, including:
the variable valve timing device advancing or delaying a rotation of an intake camshaft or an exhaust camshaft;
an intake valve or an exhaust valve configured to be operated by the intake camshaft or the exhaust camshaft respectively to open and close an intake port or an exhaust port; and
the variable tumble device that is disposed on an upstream side of the intake valve in the intake port and changes a flow of a gas being suck to form a tumble in a combustion chamber.

2. The engine having the variable valve timing device and the variable tumble device of claim 1, wherein the variable tumble device includes:
a first tumble arm having a first end rotatably coupled to a hinge and extending into the intake port in a flow direction of the gas suck by the intake port;
a second tumble arm integrated with a second end of the first tumble arm and being extended from the first tumble arm in the flow direction of the gas that flows through the intake port; and
a driver coupled to the first tumble arm and selectively rotating the first tumble arm around the hinge.

3. The engine having the variable valve timing device and the variable tumble device of claim 1, wherein the variable valve timing device is disposed to correspond to the intake camshaft to delay a rotation of the intake camshaft and to reduce a valid compression ratio.

4. The engine having the variable valve timing device and the variable tumble device of claim 3, wherein an intake valve closing (IVC) time of the intake valve is an angular displacement of a crankshaft after a bottom dead center (BDC) that is no less than 90 degrees.

5. The engine having the variable valve timing device and the variable tumble device of claim 3, wherein the variable valve timing device delays an operation angle of the intake camshaft by no less than 75 degrees.
